(19) United States
(12) Patent Application Publication
(10) Pub. No.: US 2010/0306201 A1
(43) Pub. Date: Dec. 2, 2010

(54) NEIGHBOR SEARCHING APPARATUS

(75) Inventors: Yutaka Hirano, Kawasaki-shi (JP); Mototaka Kanematsu, Yokohama-shi (JP); Toshihiro Kayama, Ota-ku (JP); Mayumi Ooto, Kawasaki-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/716,370

(22) Filed: Mar. 3, 2010

(30) Foreign Application Priority Data
May 28, 2009 (JP) 2009-129156

(51) Int. Cl. G06F 17/30

(52) U.S. Cl. 707/741; 707/769; 707/E17.014; 707/E17.002

(57) ABSTRACT

To provide a neighbor searching apparatus that can select an index suitable for each search target. A neighbor searching apparatus has: a storage part that stores a meta table containing index-dependent meta data associated with a data structure of each index; a database managing part that searches for an index associated with an instruction when receiving the instruction from a user and makes an indexing part perform a processing associated with the instruction using the index-dependent meta data associated with the index; and the indexing part that performs the processing associated with the instruction using the index-dependent meta data based on the instruction from the managing database part.

### CROSSREFERENCE TO RELATED APPLICATION

The present disclosure relates to subject matters contained in Japanese Patent Application No. 2009-129156 filed on May 28, 2009, which are expressly incorporated herein by reference in its entireties.

### BACKGROUND OF THE INVENTION

1. Field

The present invention relates to a neighbor searching apparatus for a database.

2. Related Art

A multidimensional indexing technique is a technique used for range searching or neighbor searching for a data set represented as points in a feature quantity space, such as feature quantities and component data extracted from multimedia data. This technique involves sectioning a feature quantity space with graphic elements in an inclusion relation in order to improve the efficiency of searching. Examples of the multidimensional indexing technique include R-tree and R*-tree that use a rectangle as a bounding graphic element (referred to as a cell), SS-tree that uses a sphere as a cell, and SR-tree that uses the overlapping part of a sphere and a rectangle as a cell.

Furthermore, a framework that facilitates implementation of multidimensional indexing along an abstract tree has been proposed (for example, Joseph M. Hellerstein, Jeffrey F. Naughton and Avi Pfeffer. “Generalized Search Trees for Database Systems.”, Proc. 21st Int'l Conf. on Very Large Data Bases, Zürich, September 1995, 562-5730.).

These indexing techniques are based on the concept that a multidimensional space is hierarchically divided to limit the range of searching. This is because limiting the range of searching reduces the amount of calculation accordingly. However, in a high dimensional space, a phenomenon that the distance from a certain point to its nearest point does not differ from the distance from the point to its furthest point occurs. The phenomenon known as “the curse of dimensionality” poses a problem that the range of searching cannot be limited, and as a result, the required amount of calculation approximates the amount for linear searching. In order to cope with the problem with the high dimensional space, approximate nearest neighbor searching has been studied (for example, Arya, S., Mount, D. M., Netanyahu, N. S., Silverman, R., and Wu, A., “An optimal algorithm for approximate nearest neighbor searching.”, 1994. In Proceedings of the ACM-SIAM symposium on Discrete Algorithms.).

However, the searching system described in the reference can be applied only to a balanced tree, and the searching scheme depends on the framework. Thus, the searching system has a problem that a searching scheme suitable for a given target cannot be selected.

Furthermore, the conventional approximate neighbor searching involves increasing the pruning range to (1+ε) times indiscriminatingly for every node. However, a large subtree (a node having a large number of subordinate points) and a small subtree (a subtree having a small number of subordinate points) differ in importance and search cost.

An object of the present invention is to provide a neighbor searching apparatus that can select an index suitable for each search target.

Another object of the present invention is to optimize the trade-off between the search time and the search accuracy by changing the degree of pruning based on node information (including the size of the bounding region and the number of points in the node).

### SUMMARY

According to a first aspect of the present invention, a neighbor searching apparatus is proposed. The neighbor searching apparatus comprises: storage means (a storage unit) that stores a meta table containing index-dependent meta data associated with a data structure of each index; database means (a database unit) that searches for an index associated with an instruction when receiving the instruction from a user and makes indexing means (an indexing unit) perform a processing associated with the instruction using the index-dependent meta data associated with the index; and the indexing means that performs the processing associated with the instruction using the index-dependent meta data based on the instruction from the database means.

According to a second aspect of the present invention, a neighbor searching apparatus is proposed. The neighbor searching apparatus is a neighbor searching apparatus that searches for point data that exists in the proximity of a specified query point, and a search region for the query point is determined depending on the number of subordinate points of each node in such a manner that a search range for a node having a larger number of subordinate points is smaller than a search range for a node having a smaller number of subordinate points.

According to the present invention, a neighbor searching apparatus that can select an index suitable for each search target can be provided.

Furthermore, according to the present invention, the trade-off between the search time and the search accuracy can be optimized by changing the degree of pruning based on node information (including the size of the bounding region and the number of points in the node).

### BRIEF DESCRIPTION OF THE DRAWINGS

FIG. 1 is a block diagram showing an exemplary configuration of a neighbor searching apparatus;

FIG. 2 is a diagram showing an exemplary data structure of a node table;

FIG. 3 is a diagram showing an exemplary data structure of a point table;

FIG. 4 is a diagram showing examples of the node table and the point table created from certain tree data;

FIG. 5 is a diagram showing an exemplary data structure of a meta table;

FIG. 6 is a diagram showing an exemplary data structure design for SR-tree;

FIG. 7 is a diagram showing an exemplary data structure of fundamental data of index-dependent meta data;

FIG. 8 is a diagram showing an exemplary data structure of intermediate node data of the index-dependent meta data;

FIG. 9 is a diagram showing an exemplary data structure of leaf node data of the index-dependent meta data;

FIG. 10 is a diagram showing a pseudocode of a program that executes knnSearch;

FIG. 11 is a diagram for illustrating that a large subtree is unlikely to include a neighbor point because it has a large bounding range;

FIG. 12 is a diagram for illustrating that a large subtree is unlikely to include a neighbor point because it has a large bounding range;

FIG. 13 is a flowchart showing an example of an approximate neighbor searching process performed by the neighbor searching apparatus according to an embodiment; and

FIG. 14 is a diagram for comparison between results of approximate neighbor searching according to the embodiment and a result of approximate neighbor searching according to prior art.

The accompanying drawings, which are incorporated in and constitute a part of the specification, illustrate embodiments of the invention, and together with the general description given above and the detailed description of the embodiments given below, serve to explain the principles of the invention.

### DESCRIPTION OF THE EMBODIMENTS

In the following, embodiments of the present invention will be described with reference to the drawings.

### 1. Definition of Terms

Definition of key terms used in this specification will be described below.

“Multidimensional data (point data)” refers to a piece of data composed of a plurality of values.

“k-neighbor searching” refers to a searching method that searches for k points existing in the proximity of a given point (query).

“Approximate neighbor searching” refers to searching a neighbor in an approximate manner. The approximate neighbor searching does not always provide the best result but is advantageous in that it is quicker than an ordinary neighbor searching.

“Number of subordinate points of a tree node” refers to the number of pieces of point data subordinate to a node including a subtree.

“Number of page accesses” refers to the number of I/Os. The “page” used in this context means a region of a certain size. The number of page accesses is used as an indicator of the performance of a database. This factor is not device-dependent, and the number of I/Os has a greater influence on the length of the processing time of most devices than the amount of calculation.

“Minimal bounding sphere (MBS)” refers to a hypersphere including all the subordinate points of a node.

“Minimal bounding rectangle (MBR)” refers to a hyperrectangle including all the subordinate points of a node.

“SR-tree” refers to a multidimensional index structure that defines the overlapping region of an MBS and an MBR as a bounding region.

### 1. First Embodiment

### 1.1. Example of Configuration of Neighbor Searching Apparatus

A neighbor searching apparatus according to a first embodiment of the present invention is a system that performs neighbor searching.

The neighbor searching apparatus is an information processing apparatus that comprises a central processing unit (CPU), a main memory (RAM), a read only memory (ROM) and an input/output device (I/O) and optionally an external storage device, such as a hard disk drive, or a system including such an information processing apparatus. For example, the neighbor searching apparatus is a computer, a cellular phone, an HD recorder or a home electric appliance. The ROM or the hard disk drive of the neighbor searching apparatus stores a program, the program is loaded into the main memory, and the CPU executes the program to implement the neighbor searching apparatus.

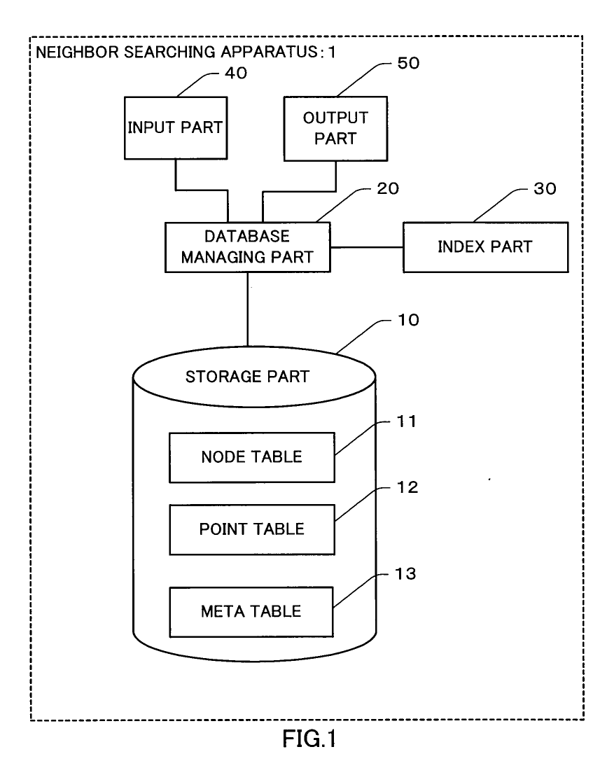

FIG. 1 shows an exemplary configuration of the neighbor searching apparatus. A neighbor searching apparatus 1 has a storage part 10, a database managing part (referred to also as a framework) 20, an indexing part 30, an input part 40 and an output part 50.

[1.1.1. Storage Part]

The storage part 10, which corresponds to storage means (or a storage unit) according to the present invention, has a function of storing data used for searching. More specifically, the storage part 10 stores a node table 11, a point table 12 and a meta table 13.

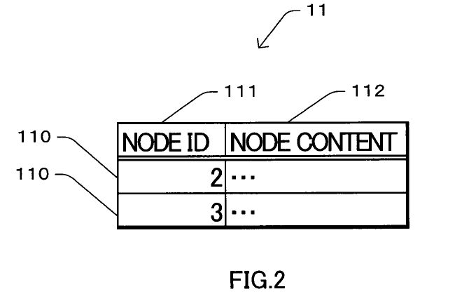

The node table 11 is data (table) that describes node information for indexes. FIG. 2 shows an exemplary data structure of the node table 11. The node table 11 has one record 110 for each node, and each record has a node ID field 111 that stores a node ID and a node content field 112 that stores a node content. The node ID is information that uniquely identifies a node, and the node content is information that indicates the node content of an index. For example, if the index structure is SR-tree, the node content includes the id of a parent node, the bounding region and the id of a child node, and the like.

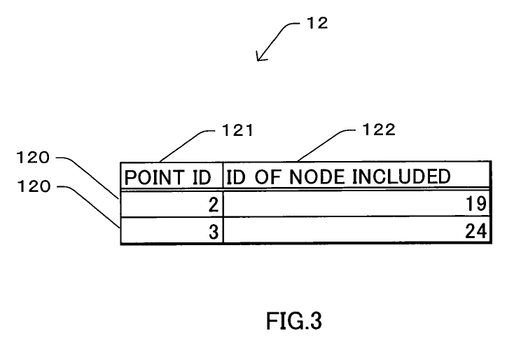

The point table 12 is data (table) that describes information about in which node each point is included. FIG. 3 shows an exemplary data structure of the point table 12. The point table 12 has one record 120 for each point, and each record has a point ID field 121 that stores a point ID and a superordinate ID field 122 that stores a node ID of a node that includes the relevant point.

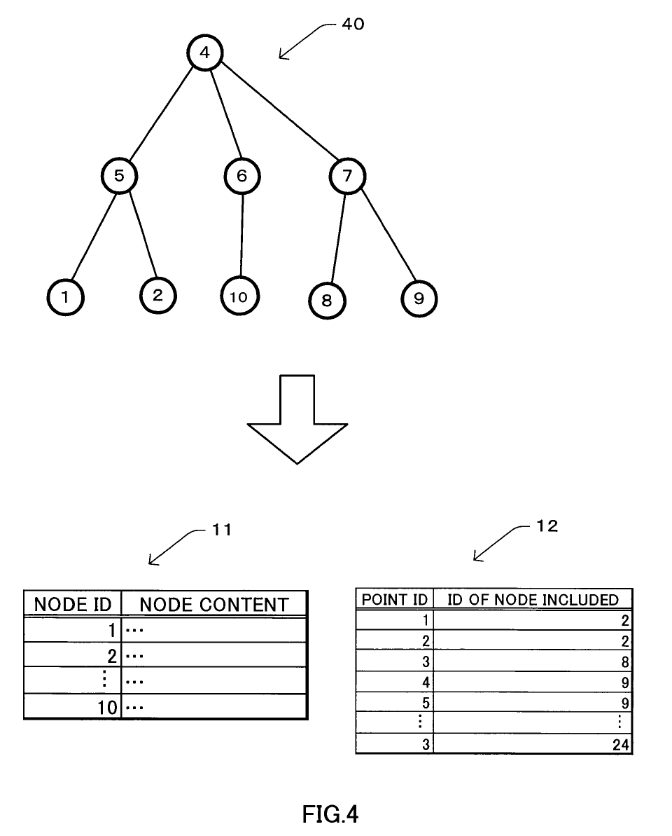

FIG. 4 is a diagram showing an example of the node table 11 and the point table 12 that are created from certain tree data. Tree data 40 has ten nodes as indicated by circles in the drawing. The number in each circle indicates the node ID of the node. In the following, each node will be distinguished from other nodes by its node ID shown in the parentheses < >. For example, a node having a node ID “1” will be referred to as a node <1>. The tree data 40 has a root node <4>, three intermediate nodes <5>, <6> and <7>, and five leaf nodes <1>, <2>, <10>, <8> and <9>.

Although a node can include point data, it is assumed that only the leaf nodes have point data in this tree data 40. The number of pieces of point data is 28, and point IDs from 1 to 28 are assigned to the 28 pieces of point data. In FIG. 4, illustration of the point data is omitted.

FIG. 4 also shows the node table 11 and the point table 12 created from the tree data 40.

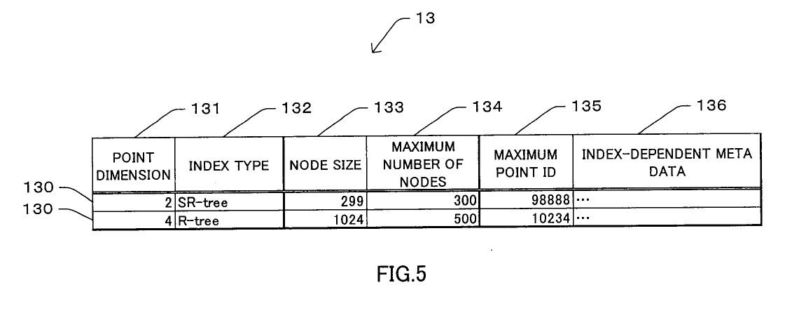

The meta table 13 is data (table) that describes meta information for indexes. FIG. 5 shows an exemplary data structure of the meta table 13. The meta table 13 has one record 130 for each index type, and each record has a point dimension field 131 that stores a point dimension (the number of feature quantities for each point), an index type field 132 that stores information that indicates the type of the index, a node size field 133 that stores the size of a node included in the index, a maximum point ID field 134 that stores the maximum number of nodes included in the index, a maximum point ID field 135 that stores the maximum value of the point IDs of the points included in the index, and an index-dependent meta data field 136 that stores index-dependent meta data for the index.

The index-dependent meta data is data used by the indexing part 30 to perform neighbor searching or the like. In the following, an example of the index-dependent meta data will be described. Although the index-dependent meta data will be described below on the assumption that the index type is SR-tree, SR-tree is not the only index type that can be used in the present invention, and the searching apparatus 1 according to the present invention can be applied to any scheme that can create an index that allows neighbor searching or the like.

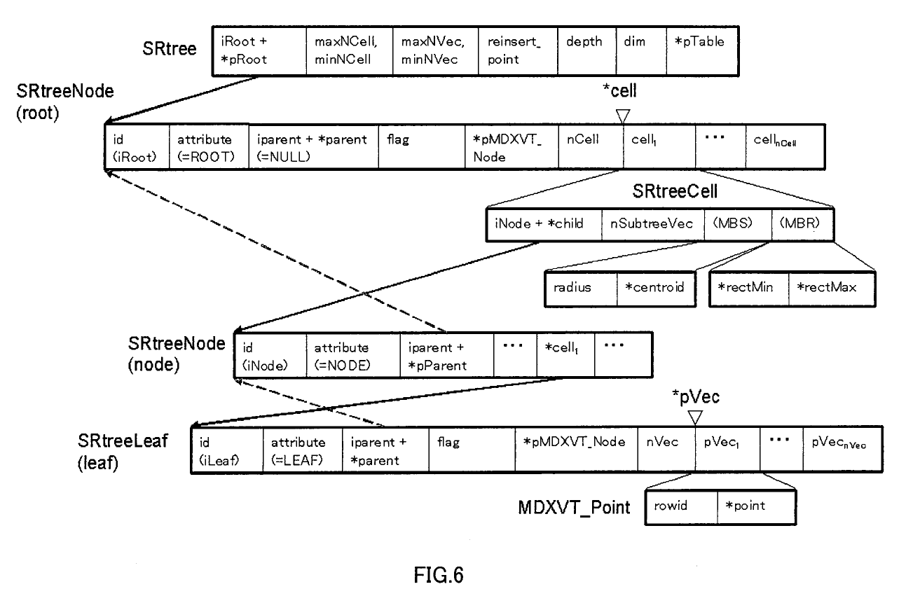

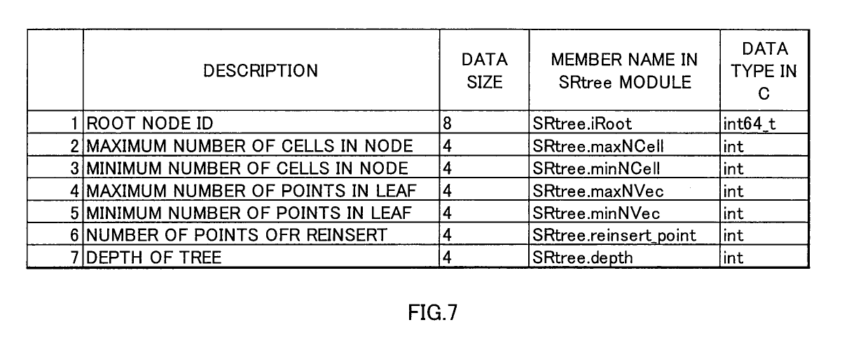

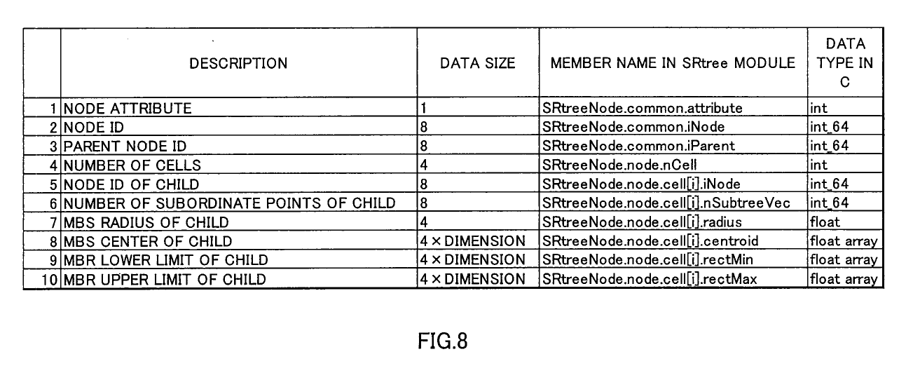

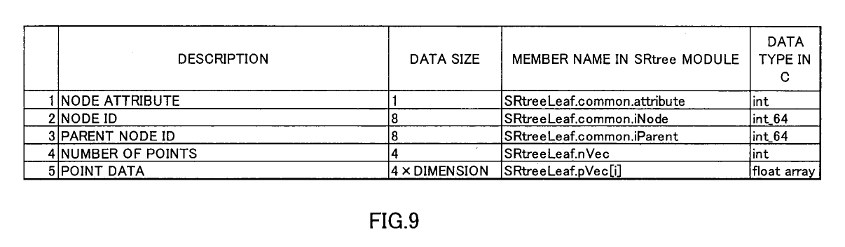

FIG. 6 is a diagram showing an exemplary data structure design for SR-tree. In the following, an example of the index-dependent meta data for SR-tree having such a data structure will be described. In this example, the index-dependent meta data is composed of fundamental data, intermediate node data, and leaf node data. FIG. 7 shows an exemplary data structure of the fundamental data of the index-dependent meta data. FIG. 8 shows an exemplary data structure of the intermediate node data of the index-dependent meta data. Entries from the entry number 5 “node ID of child” to the entry number 10 “upper limit of MBR of child” shown in the drawing are repeated the same number of times as the number of cells of the node, although those entries are shown only for one cell in the drawing. FIG. 9 is a diagram showing an exemplary data structure of the leaf node data of the index-dependent meta data. The entry number 5 “point data” shown in the drawing is repeated the same number of times as the number of points included in the node, although the entry is shown only for one point in the drawing.

Referring back to FIG. 1, the exemplary configuration of the neighbor searching apparatus 1 will be described.

[1.1.2. Database Managing Part]

The database managing part 20, which corresponds to database means (or a database unit) according to the present invention, has a function of processing a data access to the storage part 10 in response to a request from the indexing part 30. That is, the database managing part 20 has only to recognize the data content (the index-dependent meta data 136, for example) of the index as a byte string of a fixed length and does not need to consider or process the data content.

In addition, in response to receiving an instruction from a user, the database managing part 20 uses the index-dependent meta data in the meta table 13 to search for an indexing technique associated with (suitable for) the instruction and makes the indexing part 30 perform a procedure to execute the instruction.

[1.1.3. Indexing Part]

The indexing part 30, which corresponds to indexing means (or an indexing unit) according to the present invention, has a function of creating the index-dependent meta data and performing searching using the index-dependent meta data.

Specific examples of the procedure performed by the indexing part 30 will be listed below.

(1) Create

This procedure is invoked to create an index on the database. When this procedure is invoked, a procedure of returning the created index is performed.

(2) Connect

This procedure is invoked to connect to an index on the database. When this procedure is invoked, the index of the connection destination is returned.

(3) Insert (Index, Id, Point)

A procedure of inserting (id, point) in an index is performed.

(4) Delete (Index, Id)

ID performs a procedure of deleting an entry of id from an index.

(5) knnSearch (Index, Query, k, eps)

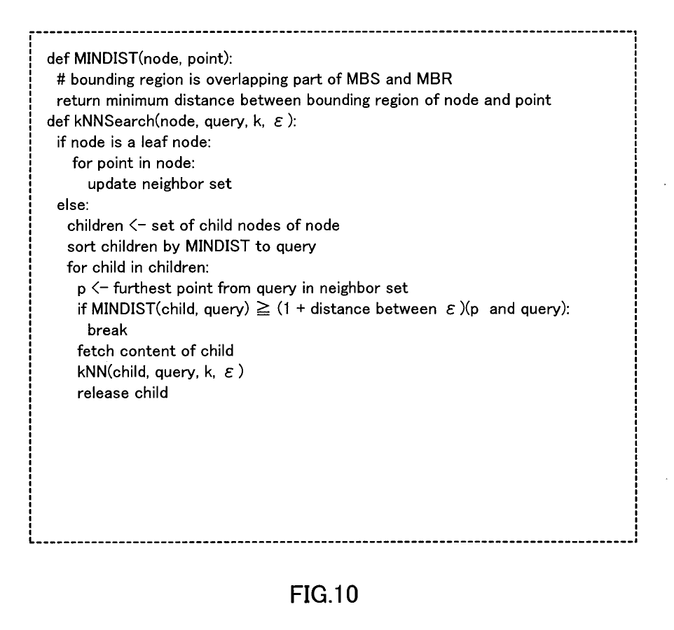

This is a procedure of performing knn searching. As a result of this procedure, k points close to a query are retrieved using an error coefficient eps and returned. FIG. 10 shows a pseudocode of a program that executes knnSearch.

(6) searchByID (Index, Id)

This is a procedure of ID returning a point of id.

(7) costKNN (Index)

This is a procedure of estimating and returning the kNN search cost.

(8) getMetadataLength (Dimension)

The indexing part 30 returns the region length of the index-dependent meta data with reference to the point dimension.

(9) Free (Index)

This is a procedure of releasing an index object on a memory.

Referring back to FIG. 1, the exemplary configuration of the neighbor searching apparatus 1 will be described.

[1.1.4. Input Part, Output Part]

The input part 40 is a keyboard, a pointing device, a touch panel or the like and is used by the user to input an instruction or other information. The input information includes an index specified to be used, a specified point (query) for searching, and the number k of elements for k-neighbor searching, for example.

The output part 50 is a display, a printer, a speaker or the like and is used to make an inquiry to the user or output the search result to the user.

### 2. Second Embodiment

A second embodiment of the present invention is the neighbor searching apparatus described above that is configured to perform approximate neighbor searching by changing the degree of pruning depending on the side of the node (cell).

A conventional approximate neighbor searching technique considers an approximation coefficient uniform. However, a large subtree (a subtree having a large number of subordinate points) and a small subtree (a subtree having a small number of subordinate points) differ in importance and search cost. That is, from the viewpoint that a large subtree has a large number of subordinate points, the subtree is likely to include a neighbor point but requires a higher search cost because it includes a large number of points. On the other hand, from the viewpoint that a large subtree has a large bounding region, the subtree is not likely to include a neighbor point in a particular part of the large bounding region (the subordinate points can be unevenly distributed). A small subtree has the opposite characteristics.

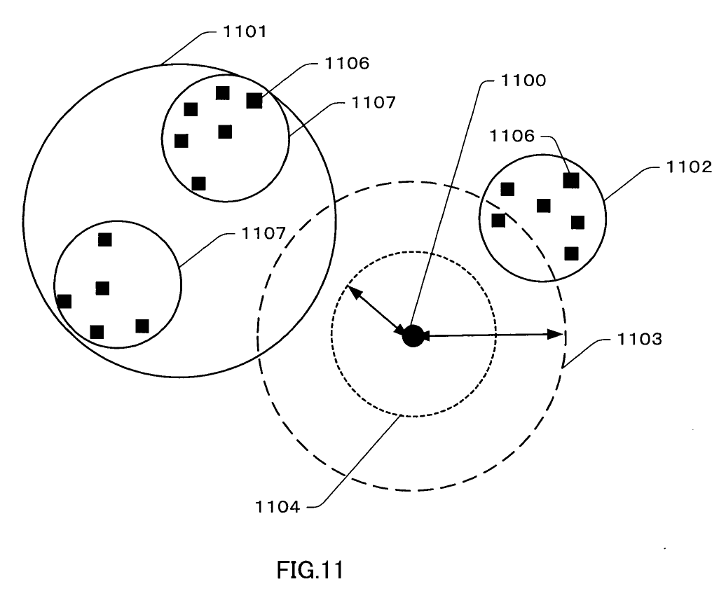

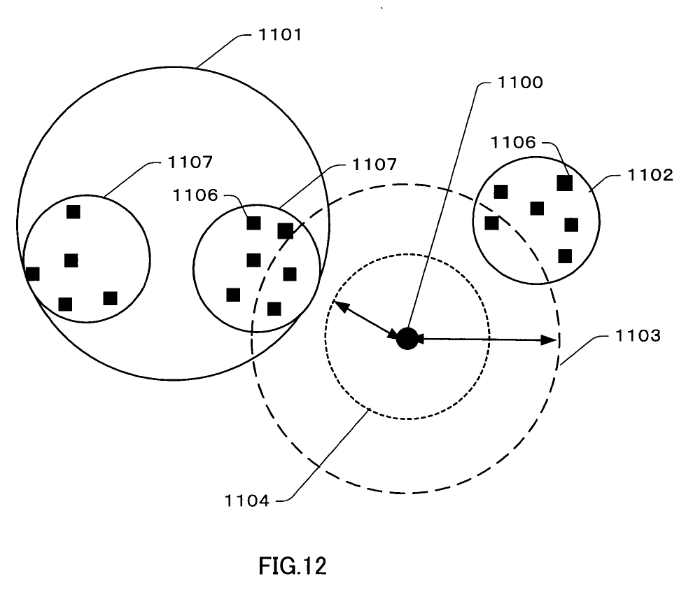

FIGS. 11 and 12 are diagrams for illustrating that a large subtree, which as a large bounding region, is not likely to include a neighbor point. In FIGS. 11 and 12, a large subtree 1101 and a small subtree 1102 exist for a query point 1100. The large subtree 1101 has two child nodes 1107, and each child node 1107 includes point data 1106 (the point data are represented by black squares in the drawings. Reference numeral 1106 is assigned only to a representative one of the data point and is omitted for the remaining data point).

The neighbor searching apparatus 1 according to this embodiment performs approximate neighbor searching using a search region 1104 for the large subtree and a search region 1103 for the small subtree. If a nearest point to the query point 1100 lies in a search region, the point data 1106 included in the subtree is treated as a target point of approximate neighbor searching. If the nearest point does not lie in a search region, the point data in the subtree is not treated as a target (in other words, the subtree is pruned).

In general, as shown in FIGS. 11 and 12, the point data are not evenly distributed in the large subtree but unevenly distributed. When a search region does not include the unevenly distributed point data, it is undesirable that the subtree is treated as a target of approximate neighbor searching. In the example shown in FIG. 11, the search region 1103 for the large subtree includes no nearest point of the large subtree, the point data in the large subtree 1101 are not treated as a target (in other words, the subtree is pruned). Since the point data 1106 in the large subtree 1101 are far from the query point 1100, it is preferred that the point data 1106 are not treated as a target of searching in this example.

In the example shown in FIG. 12, as in the example shown in FIG. 11, the search region 1104 for the small subtree includes no nearest point of the small subtree, and thus, the point data in the small subtree 1102 are not treated as a target. However, point data included in the large subtree 1101 are close to the query point 1100. In this case, it is normally preferred that the point data included in the large subtree 1101 are treated as a target of approximate neighbor searching. However, based on the determination that such a situation does not frequently occur, the large subtree is pruned as in the example shown in FIG. 11.

According to this embodiment, approximate neighbor searching is performed by changing a value that determines the size (radius) of the search regions 1103 and 1104 for the large subtree 1101 and the small subtree 1102. The search region is defined as a circle (a hypersphere in a multidimensional space) centered at the query point 1100 and having a radius r. The radius r is determined according to the following formula (Expression 1).

r=(provisional k in the course of searching−distance between neighbor bounding region and query)/(1+ε′) [Expression 1]

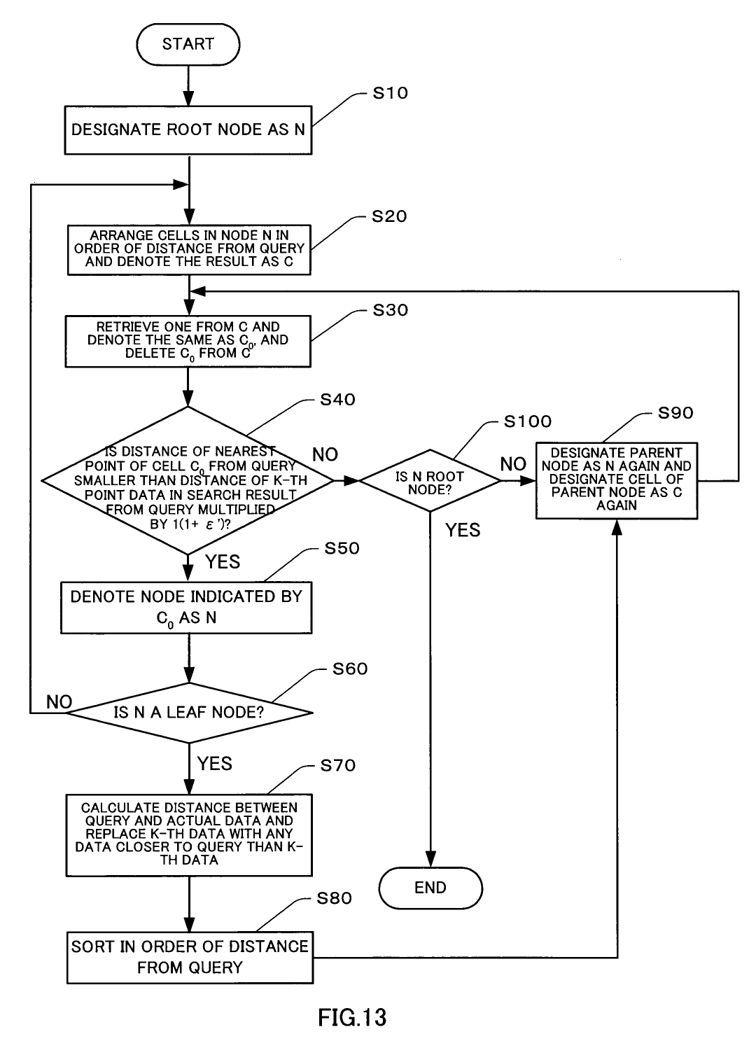

FIG. 13 is a flowchart showing an example of the approximate neighbor searching process performed by the neighbor searching apparatus 1 according to this embodiment, or more specifically, the indexing part 30 thereof.

Once the approximate neighbor searching process is started, the indexing part 30 acquires a query point q, the number k of points to be searched for and an approximation coefficient ε as user instruction information. The instruction information is input by the user through the input part 40, transmitted to the database managing part 20 and then passed from the database managing part 20 to the indexing part 30.

The indexing part 30 refers to the meta table 13, or more specifically, the index-dependent meta data 136 and denotes the root node (Root) by N (stores the root node as a node N) (step S10). Then, the indexing part 30 arranges the cells in the node N in ascending order of distance from the query point and stores the result as C (step S20).

Then, the indexing part 30 retrieves one cell from the result C. The cell is denoted by C₀. Besides, the indexing part 30 deletes the cell C₀ from the result C (step S30).

Then, the indexing part 30 calculates ε′ (epsilon prime: referred to as a modified approximation coefficient in order to distinguish from the approximation coefficient ε) from the approximation coefficient ε.

The following (Expression 2) is a formula for calculating the modified approximation coefficient ε′.

$${ɛ}^{′} = min ( \begin{matrix}ɛ , \\ max ( 0 , γɛ \frac{log ( \begin{matrix}number of \\ subordinate points \\ of node\end{matrix} )}{log ( \begin{matrix}number of \\ subordinate points \\ of whole tree\end{matrix} )} )\end{matrix} ) \qquad [ Expression 2 ]$$

In the above formula, γ is a constant (which can also be given by the query).

ε′ meets a condition that 0≦ε′≦ε.

Therefore, departure from the worst case guarantee for the given approximation coefficient ε does not occur.

The modified approximation coefficient ε′ is used to determine the radius r of the search regions 1103 and 1104 according to the following formula (Expression 3).

r=(current provisional k−distance between neighbor bounding region and query)/(1+ε′) [Expression 3]

Then, the indexing part 30 determines whether or not the distance between the nearest point of the cell C₀ to the query point and the query point is smaller than the distance between the k-th point data in the search result to the query point q multiplied by 1/(1+ε′) (step S40).

If it is determined in step S40 that the distance between the nearest point of the cell C₀ to the query point and the query point is smaller than the distance between the k-th point data in the search result to the query point q multiplied by 1/(1+ε′) (that is, if YES in step S40), the indexing part 30 designates the node indicated by the cell C₀ as a new node N (step S50). Then, the indexing part 30 determines whether or not the new node N is a leaf node (step S60). If it is determined in step S60 that the node N is not a leaf node (that is, if NO in step S60), the indexing part 30 returns to the processing in step S20. On the other hand, if it is determined in step S60 that the node N is a leaf node (that is, if YES in step S60), the indexing part 30 calculates the distance between each piece of the point data in the cell C₀ and the query point q and replaces the k-th point data in the previously retrieved point data with any point data closer to the query point than the k-th point data (step S70).

Then, the indexing part 30 sorts the point data that are candidates for neighbor point data in order of distance from the query point (step S80). Then, the indexing part 30 designates the parent node of the current node N as the node N again and designates the set of cells of the parent node as C again (step S90). Then, the indexing part 30 returns to step S30 described above.

If it is determined in step S40 that the distance between the nearest point of the cell C₀ to the query point and the query point is not smaller than the distance between the k-th point data in the search result to the query point q multiplied by 1/(1+ε′) (that is, if NO in step S40), the indexing part 30 determines whether or not the current node N is a root node (step S100). If it is determined that the node N is a root node (that is, if YES in step S100), the indexing part 30 ends the approximate neighbor searching process and outputs the first to k-th point data stored at this point as the approximate neighbor search result. On the other hand, if it is determined that the node N is not a root node (that is, if NO in step S100), the indexing part 30 proceeds to step S90 described above and continues the approximate neighbor searching process.

This is the end of the description of an example of the approximate neighbor searching process according to this embodiment.

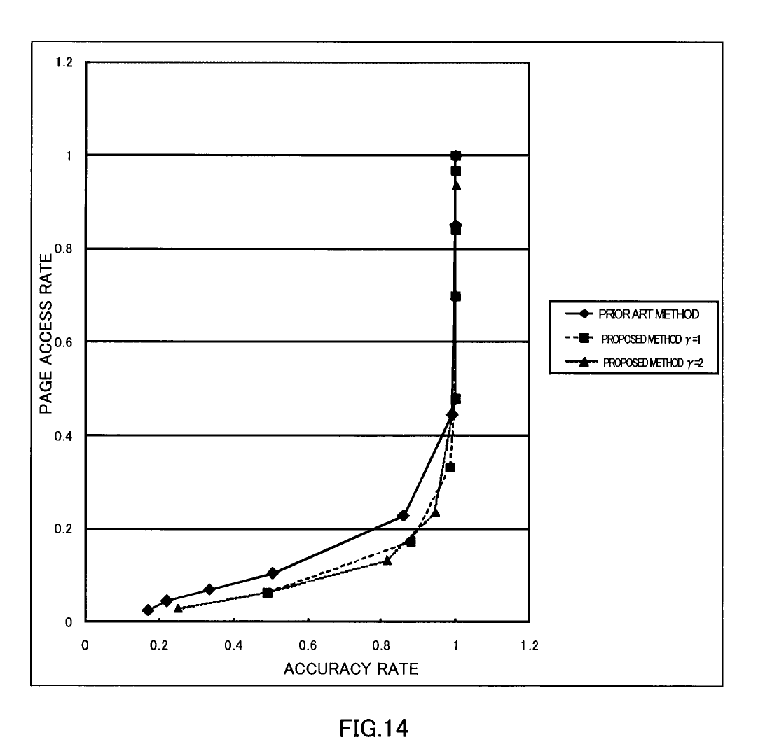

FIG. 14 shows comparison between results of approximate neighbor searching according to this embodiment and a result of approximate neighbor searching according to prior art. In this drawing, the vertical axis indicates the page access rate, and the horizontal axis indicates the match rate of the point data obtained by neighbor searching (a rate of 1 means perfect match). In addition, cases where the constant γ in the formula for calculating the modified approximation coefficient ε′ described above is 1 and 2 are also compared.

From the results shown in FIG. 14, it is verified that the accuracy rate of the approximate neighbor searching method according to this embodiment is higher than the prior art approximate neighbor searching for the same page access rate.

Additional advantages and modifications will readily occur to those skilled in the art. Therefore, the invention in its broader aspects is not limited to the specific details or representative embodiments shown and described herein. Accordingly, various modification may be made without departing from the spirit or scope of the general inventive concept as defined by the appended claims and their equivalents.

What is claimed is:

1. A neighbor searching apparatus, comprising:
a storage unit that stores a meta table containing index-dependent meta data associated with a data structure of each index;
a database unit that searches for an index associated with an instruction when receiving the instruction from a user, and makes an indexing unit perform a processing associated with the instruction using the index-dependent meta data associated with the index; and
the indexing unit that performs the processing associated with the instruction using the index-dependent meta data based on the instruction from the database unit.

2. A neighbor searching apparatus that searches for point data that exists in the proximity of a specified query point, wherein a search region for the query point is determined depending on the number of subordinate points of each node in such a manner that a search range for a node having a larger number of subordinate points is smaller than a search range for a node having a smaller number of subordinate points.

3. The apparatus according to claim 2, wherein a radius r that determines the search region is calculated according to the following formula:
r=(provisional k in the course of searching−distance between neighbor bounding region and query)/(1+ε′) [Expression 1]
and a coefficient ε′ in the formula that determines the radius r is calculated according to the following formula:
$${ɛ}^{′} = min ( \begin{matrix}ɛ , \\ max ( 0 , γɛ \frac{log ( \begin{matrix}number of \\ subordinate points \\ of node\end{matrix} )}{log ( \begin{matrix}number of \\ subordinate points \\ of whole tree\end{matrix} )} )\end{matrix} ) \qquad [ Expression 2 ]$$
(where γ and ε each represent an arbitrary constant).
